(19) United States
(12) Patent Application Publication
(10) Pub. No.: US 2024/0097198 A1
(43) Pub. Date: Mar. 21, 2024

(54) APPARATUS AND METHOD FOR A BATTERY CELL INCLUDING A THERMAL BARRIER AT A POSITIVE BATTERY TERMINAL AND CAN INTERFACE

(71) Applicant: GM GLOBAL TECHNOLOGY OPERATIONS LLC, Detroit, MI (US)

(72) Inventors: Liang Xi, Northville, MI (US); Linan Zheng, Troy, MI (US); Ryan P. Hickey, Austin, TX (US); SriLakshmi Katar, Troy, MI (US); Yuvraj Dewan, Ferndale, MI (US)

(73) Assignee: GM GLOBAL TECHNOLOGY OPERATIONS LLC, Detroit, MI (US)

(21) Appl. No.: 17/945,670

(22) Filed: Sep. 15, 2022

(51) Int. Cl. H01M 10/0587; H01M 10/653; H01M 10/658; H01M 50/103; H01M 50/107; H01M 50/30; H01M 50/543

(52) U.S. Cl. CPC H01M 10/0587; H01M 10/653; H01M 10/658; H01M 50/103; H01M 50/107; H01M 50/30; H01M 50/543; H01M 2220/20

(57) ABSTRACT

An apparatus for a battery cell is provided. The apparatus includes the battery cell. The battery cell includes an electrode stack including at least one pair of an anode electrode and a cathode electrode and a can including a wall encapsulating the electrode stack. The battery cell further includes a positive battery terminal connected to the electrode stack and projecting outside of the can. The battery cell further includes a negative battery terminal connected to the electrode stack. The positive battery terminal and the negative battery terminal are configured for providing electrical energy. The battery cell further includes a thermal barrier adjoining the can and the positive battery terminal. The thermal barrier seals gases within the battery cell from exiting the battery cell between the can and the positive battery terminal at an ambient temperature of at least 600° C.

### INTRODUCTION

The disclosure generally relates to an apparatus and method for a battery cell including a thermal barrier at a positive battery terminal and can interface.

A battery includes at least one pair of anode electrode and cathode electrode and a separator disposed between the anode electrode and the cathode electrode. Each of the anode electrode and the cathode electrode include or are formed upon a current collector which may be a conductive metal piece utilized to conduct electrical energy from the respective electrode to a battery terminal. The anode electrode is connected to a negative battery terminal, and the cathode electrode is connected to a positive battery terminal. A battery may include a can or an outer rigid housing useful to contain and protect the electrodes and separator. The can may be constructed of a metal. The battery terminals may each be a rivet, a metallic structure welded to the battery, or other terminal constructions utilized in the art.

A jellyroll electrode stack includes a flexible stack of layers including a separator layer, a cathode layer, an inert laminate layer, and an anode layer. These flexible layers may be rolled into a cylindrical shape. Viewing an end of the jellyroll electrode stack, the layers may appear as a swirl, with the anode layer and the cathode layer separated by the separator layer. The anode layer may be connected to a negative battery terminal through a first current collector, and the cathode layer may be connected to a positive battery terminal through a second current collector. The jellyroll electrode stack may be generally cylindrical in shape and may be placed within a cylindrical can.

### SUMMARY

An apparatus for a battery cell is provided. The apparatus includes the battery cell. The battery cell includes an electrode stack including at least one pair of an anode electrode and a cathode electrode and a can including a wall encapsulating the electrode stack. The battery cell further includes a positive battery terminal connected to the electrode stack and projecting outside of the can. The battery cell further includes a negative battery terminal connected to the electrode stack. The positive battery terminal and the negative battery terminal are configured for providing electrical energy. The battery cell further includes a thermal barrier adjoining the can and the positive battery terminal. The thermal barrier seals gases within the battery cell from exiting the battery cell between the can and the positive battery terminal at an ambient temperature of at least 600° C.

In some embodiments, the thermal barrier is constructed with an epoxy, a room-temperature vulcanizing silicone, or polyurethane.

In some embodiments, the battery cell further includes an insulator disposed between the can and the positive battery terminal. The thermal barrier is disposed to cover an outside surface of the insulator.

In some embodiments, the electrode stack is a jellyroll electrode stack, and the can is cylindrically shaped.

In some embodiments, the can is a rectangularly-shaped prismatic can.

In some embodiments, the battery cell further includes a vent configured for permitting the gases to escape from the battery cell through the vent.

In some embodiments, the battery cell includes a first end portion and a second end portion distal from the first end portion. The thermal barrier is disposed upon the first end portion. The vent is disposed upon the second end portion.

In some embodiments, the thermal barrier includes a first thermal barrier. The battery cell further includes a second thermal barrier surrounding the negative battery terminal.

According to one alternative embodiment, a device including a battery cell is provided. The device includes the battery cell. The battery cell includes an electrode stack including at least one pair of an anode electrode and a cathode electrode and a can including a wall encapsulating the electrode stack. The battery cell further includes a positive battery terminal connected to the electrode stack and projecting outside of the can. The battery cell further includes a negative battery terminal connected to the electrode stack. The positive battery terminal and the negative battery terminal are configured for providing electrical energy. The battery cell further includes a thermal barrier adjoining the can and the positive battery terminal. The thermal barrier seals gases within the battery cell from exiting the battery cell between the can and the positive battery terminal at an ambient temperature of at least 600° C.

In some embodiments, the device includes a vehicle.

In some embodiments, the thermal barrier is constructed with an epoxy, a room-temperature vulcanizing silicone, or polyurethane.

In some embodiments, the battery cell further includes an insulator disposed between the can and the positive battery terminal. The thermal barrier is disposed to cover an outside surface of the insulator.

In some embodiments, the electrode stack is a jellyroll electrode stack, and the can is cylindrically shaped.

In some embodiments, the can is a rectangularly-shaped prismatic can.

In some embodiments, the battery cell further includes a vent configured for permitting the gases to escape from the battery cell through the vent.

In some embodiments, the battery cell includes a first end portion and a second end portion distal from the first end portion. The thermal barrier is disposed upon the first end portion. The vent is disposed upon the second end portion.

In some embodiments, the thermal barrier includes a first thermal barrier. The battery cell further includes a second thermal barrier surrounding the negative battery terminal.

According to one alternative embodiment, a method for a battery cell including a thermal barrier at a positive battery terminal and can interface is provided. The method includes creating a thermal barrier including a coating of thermal barrier material around a perimeter of a positive battery terminal of the battery cell configured for adjoining the positive battery terminal and a can of the battery cell and for sealing gases within the battery cell from exiting the battery cell between the positive battery terminal and the can. The thermal barrier material is configured to continue sealing the gases within the battery cell at an ambient temperature of at least 600° C.

In some embodiments, creating the thermal barrier is performed prior to the battery cell being fully assembled.

In some embodiments, creating the thermal barrier is performed after a remainder of the battery cell is fully assembled.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates in side view and partial cross-section an exemplary battery cell including a can, a positive battery terminal, and a thermal barrier adjoining the can to the positive battery terminal, in accordance with the present disclosure;

FIG. 2 schematically illustrates the battery cell of FIG. 1 in top view, in accordance with the present disclosure;

FIG. 3 schematically illustrates an exemplary alternative battery cell in top view, wherein the battery cell is prismatic, in accordance with the present disclosure;

FIG. 4 schematically illustrates an exemplary battery cell in cross-sectional view, in accordance with the present disclosure;

FIG. 5 schematically illustrates an exemplary device including a vehicle including an energy storage device which includes at least one battery cell of FIG. 1, in accordance with the present disclosure;

FIG. 6 is a flowchart illustrating a first method for a localized thermal barrier at a positive battery terminal and can interface of a battery, in accordance with the present disclosure;

FIG. 7 is a flowchart illustrating a second method for a localized thermal barrier at a positive battery terminal and can interface of a battery, in accordance with the present disclosure; and

FIG. 8 schematically illustrates an alternative battery cell in cross-sectional view wherein the thermal barrier acts as an insulator, in accordance with the present disclosure.

### DETAILED DESCRIPTION

A battery may be exposed to high temperatures. During exposure to high temperatures, the battery may outgas or emit gases. A battery positive terminal may be located close to a current bus or a metallic structure used to conduct electrical energy. The positive battery terminal may be selectively connectable to the current bus. In an open circuit condition, the positive battery terminal may be disconnected from the current bus such that no path for electrical conduction exists between the positive battery terminal and the current bus. It may be desirable to prevent outgassing in an open circuit area such as between the positive battery terminal and the current bus.

A battery includes a positive battery terminal, a negative battery terminal, and a can. The can may be a metallic case disposed around the at least one anode electrode of the battery, the at least one cathode electrode of the battery, and the separator(s) disposed between each anode electrode and cathode electrode pair. In one embodiment, the metallic case may serve as the negative battery terminal. The can may have a vent, a vent plate, or a portion of the battery configured to vent distal from the positive battery terminal and a nearby current bus in case the battery begins to outgas. An insulator may be utilized to prevent contact and electrical conduction between the positive battery terminal and the can. When operating in low or nominal temperature ranges, the insulator may additionally seal gases within the battery in the area of the positive battery terminal, preventing gases from escaping the battery between the positive battery terminal and the can. However, insulators may be constructed with materials with relatively low operating ranges and may degrade during high temperature events at 150° C. or higher. In such an instance, as the insulator degrades, it may lose the function of sealing the battery in the area of the positive battery terminal.

An apparatus and method for an apparatus and method for a localized thermal barrier at a positive battery terminal and can interface of a battery is provided. The apparatus may include a thermal barrier adjoining the can of the battery to the battery positive terminal. The thermal barrier acts as a seal, preventing gas from escaping from the battery between the positive battery terminal and the can.

In one embodiment, the thermal barrier contacts or is disposed in contact with both the positive battery terminal and a metallic can. In this embodiment, the thermal barrier may be constructed with a non-conductive or insulating material to prevent electrical conduction from the positive battery terminal to the metallic can.

In one embodiment, the thermal barrier material may include a melting temperature higher than a maximum can surface temperature. One exemplary cylindrical battery cell has a maximum can surface temperature of 685° C. An appropriate thermal barrier material may be selected with a melting temperature in excess of the maximum can surface temperature. In the provided exemplary cylindrical battery cell, a thermal barrier may be constructed with a 1 k or 2 k liquid material silicone-based product with a melting temperature of 700° C.

The thermal barrier may be created upon the battery by applying or disposing thermal barrier material around the positive battery terminal and sealing the thermal barrier material to both the positive battery terminal and the can of the battery. The thermal barrier may take a form of an annular coating or film on the can surrounding the positive battery terminal. The thermal barrier material may be applied in the existing cell manufacturing process or prior to cell assembly. The thermal barrier material may be applied before a process to weld the positive battery terminal to the battery. In another embodiment, the thermal barrier material may be applied after the cell terminals are welded together.

The disclosed thermal barrier may be applied to battery cell formats other than cylindrical cells. The disclosed thermal barrier may be applied to prismatic can cells or another enclosure that needs to maintain mechanical integrity to maintain a gas seal during a high temperature event.

The thermal barrier material may be applied through depositing, spraying, coating, or other similar processes. The disclosed method may include applying a thermal barrier material to a battery terminal-to-can interface area on a battery cell to prevent an undesired gas/particle leakage from other than a desired vent path for the battery cell. A thermal barrier may be utilized around a positive battery terminal or a negative battery terminal.

The thermal barrier material may be an epoxy, a room-temperature vulcanizing silicone, polyurethane, or another adhesive that may provide sealing at high temperatures. In one embodiment, the thermal barrier material may be selected with a melting temperature in excess of 600° C. In one embodiment, the thermal barrier material may be selected with a melting temperature in excess of 700° C. In one embodiment, the thermal barrier material may be selected with a melting temperature in excess of 800° C.

The thermal barrier material may be applied to fully cover the insulator. In one embodiment, the thermal barrier will include a thickness of 1.0 mm±0.2 mm. In one embodiment, a thickness of the thermal barrier material may be restrained in order to remain below a battery terminal height to avoid interference with a busbar.

In one embodiment, the thermal barrier material may be applied to the battery cell after the cell terminals are welded together. In one embodiment, two thermal barriers may be utilized to seal both a positive battery terminal to the can of the battery and a negative battery terminal to the can of the battery, resulting in excellent, robust seal integrity.

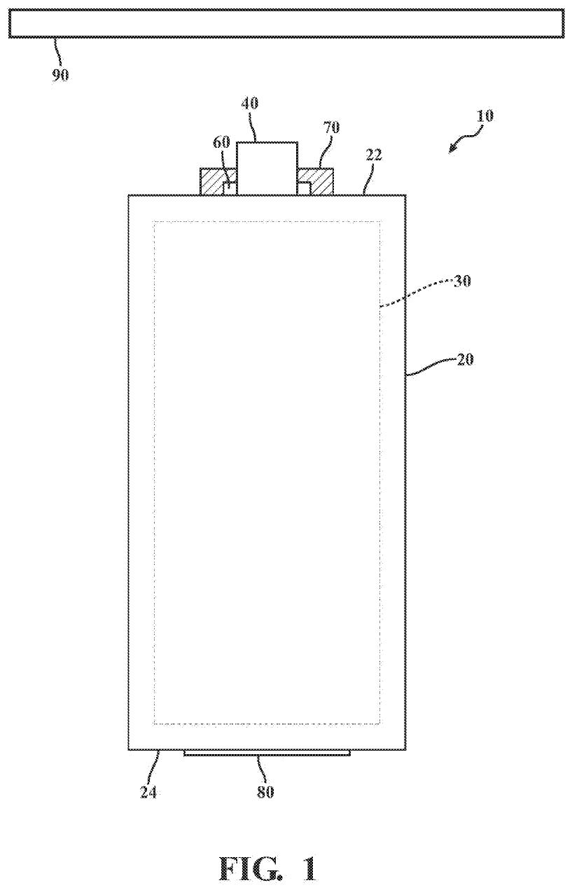

Referring now to the drawings, wherein like reference numbers refer to like features throughout the several views, FIG. 1 schematically illustrates in side view and partial cross-section an exemplary battery cell 10 including a can 20, a positive battery terminal 40, and a thermal barrier 70 adjoining the can 20 to the positive battery terminal 40. The can 20 is illustrated in side view. The can 20 may be described as an enclosure including at least one wall configured for surrounding and encapsulating an electrode stack within the can 20. The can 20 may be constructed of steel, aluminum, aluminum alloy or other materials in the art. A positive battery terminal and can interface may be defined to include an area around a perimeter of the positive battery terminal 40 proximate to or facing the can 20. The positive battery terminal 40, the thermal barrier 70 and an optional insulator 60 are illustrated in cross-sectional view. In one embodiment, the thermal barrier 70 may extend into a gap between the positive battery terminal 40 and the can 20, taking a place of the insulator 60. A jellyroll electrode stack 30 is illustrated within the can 20 with dotted lines. A jellyroll electrode stack 30 may be generally cylindrically shaped, and the can 20 may be cylindrically shaped. The positive battery terminal 40 is illustrated on a first end portion 22 of the battery cell 10. A vent 80 is illustrated on a second end portion 24 of the battery cell 10 distal from the first end portion 22. The can 20 is electrically connected to a current collector of the jellyroll electrode stack 30 and acts as a negative battery terminal. The vent 80 is configured for permitting gases to escape from the battery cell 10 in a desired location. This desired location may be selected based upon rapidly expelling the gases to an ambient air environment where surrounding features and systems are inert with respect to the gases being expelled.

A neighboring current conducting metallic piece 90 is illustrated proximate to but physically separate from the battery cell 10. In one embodiment, the vent 80 is configured to expel gases in an area not including the neighboring current conducting metallic piece 90.

The positive battery terminal 40 is connected to a current collector of the jellyroll electrode stack 30 and extends through an opening in the can 20. Under nominal or design temperature conditions, the insulator 60 is configured to electrically insulate the positive battery terminal 40 from the can 20 and additionally to seal gases within the battery cell 10 from escaping the battery cell 10 near the positive battery terminal 40 or through the gap between the positive battery terminal 40 and the can 20. The insulator 60 may be constructed with polyethylene (PE), polypropylene (PP), or any other type of polymer. Under high temperature conditions or during a high temperature event in excess of 150° C., the insulator 60 may degrade and lose the ability to seal the gases within the battery cell 10. The thermal barrier 70 may act as a redundant seal to the insulator 60, maintaining the ability to seal the gases within the battery cell 10 from escaping from the gap between the positive battery terminal 40 and the can 20.

The thermal barrier 70 may be constructed with an epoxy, a room-temperature vulcanizing silicone, polyurethane, or another adhesive that may provide sealing at high temperatures. The thermal barrier 70 may be disposed to cover an outside surface of the insulator 60.

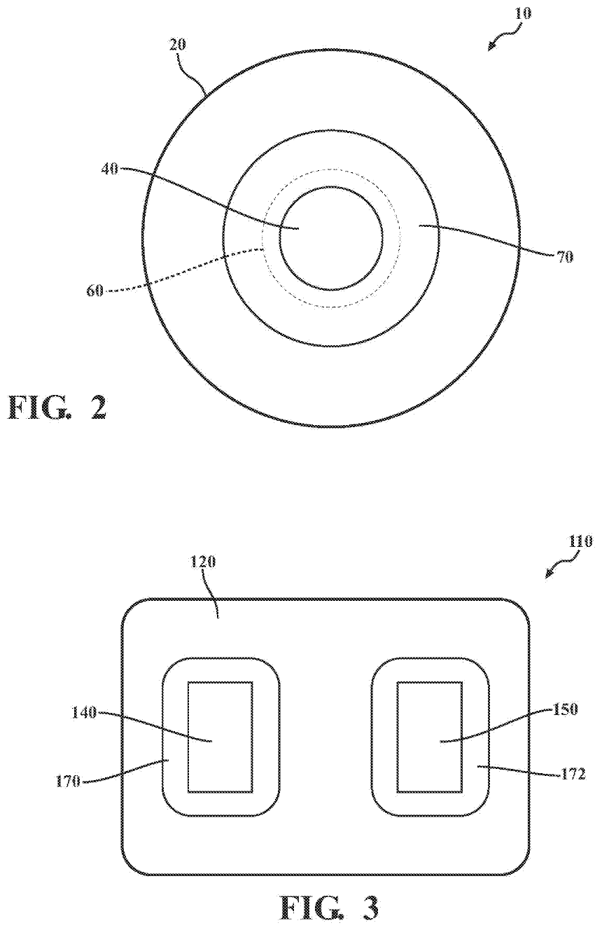

FIG. 2 schematically illustrates the battery cell 10 of FIG. 1 in top view. The battery cell 10 is illustrated including the can 20, the positive battery terminal 40, and the thermal barrier 70. The insulator 60 is hidden from direct view, and a location of the insulator within or under the thermal barrier 70 is illustrated with a dotted line. The can 20 is illustrated with a round shape when viewed from the top, wherein the battery cell 10 is illustrated as a cylindrical unit or is cylindrically shaped.

FIG. 3 schematically illustrates an exemplary alternative battery cell 110 in top view, wherein the battery cell 110 is prismatic. The prismatic battery cell 110 is illustrated including a rectangularly-shaped can 120, a positive battery terminal 140, and a negative battery terminal 150. The positive battery terminal 140 is surrounded by a first thermal barrier 170, and the negative battery terminal 150 is surrounded by a second thermal barrier 172.

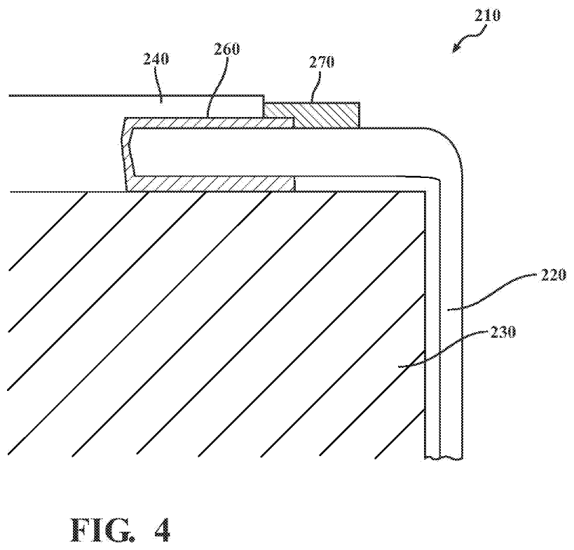

FIG. 4 schematically illustrates an exemplary battery cell 210 in cross-sectional view. The battery cell 210 is illustrated including a can 220, an electrode stack 230, a positive battery terminal 240, an insulator 260, and a thermal barrier 270. The thermal barrier 270 extends around a perimeter of the positive battery terminal 240 and acts as a redundant seal to the insulator 260, preventing gases from within the battery cell 210 from exiting from a gap between the positive battery terminal 240 and the can 220. The positive battery terminal 240 may be welded to, riveted to, or otherwise attached to or may be an extension of a current collector of the electrode stack 230.

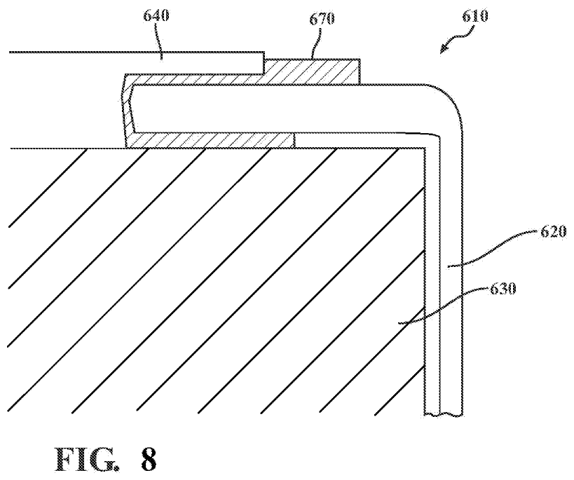

FIG. 8 schematically illustrates an alternative battery cell 610 in cross-sectional view wherein the thermal barrier 670 acts as an insulator. The battery cell 610 is illustrated including a can 620, an electrode stack 630, a positive battery terminal 640, and a thermal barrier 670. The thermal barrier 670 extends around a perimeter of the positive battery terminal 640 and acts as an insulator, preventing electrical contact between the positive battery terminal 640 and the can 620, and as a seal, preventing gases from within the battery cell 610 from exiting from a gap between the positive battery terminal 640 and the can 620. The positive battery terminal 640 may be welded to, riveted to, or otherwise attached to or may be an extension of a current collector of the electrode stack 630.

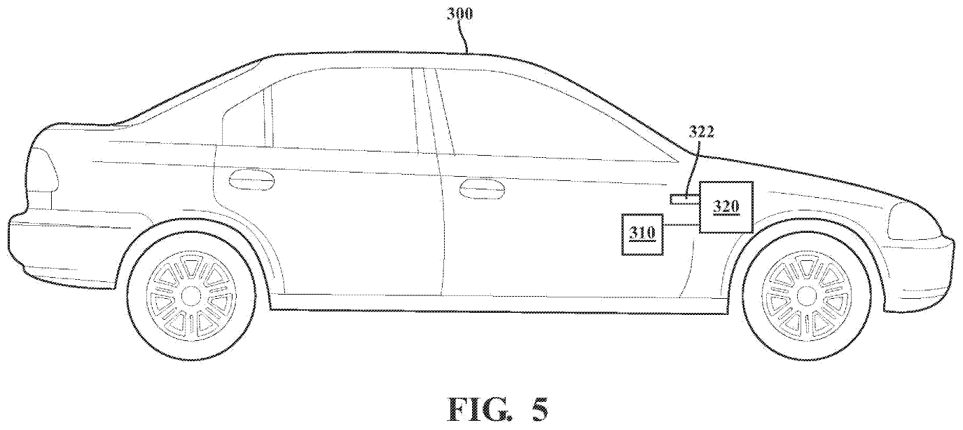

FIG. 5 schematically illustrates an exemplary device 300 including a vehicle including an energy storage device 310 which includes at least one battery cell 10 of FIG. 1. The energy storage device 310 receives electrical energy and stores the electrical energy as chemical energy. When electrical energy is needed by the device 300, the energy storage device 310 provides energy to the device 300. In the embodiment of FIG. 5, the energy storage device 310 provides electrical energy to an electric machine 320 which is configured to provide an output torque useful to provide motive force to the device 300 through an output component 322. The device 300 is exemplary and a number of different types of systems and applications are envisioned as alternatives to the device 300. Variations of the device 300 include but are not limited to powertrain systems, boats, and back-up power systems. The disclosure is not intended to be limited to the examples provided herein.

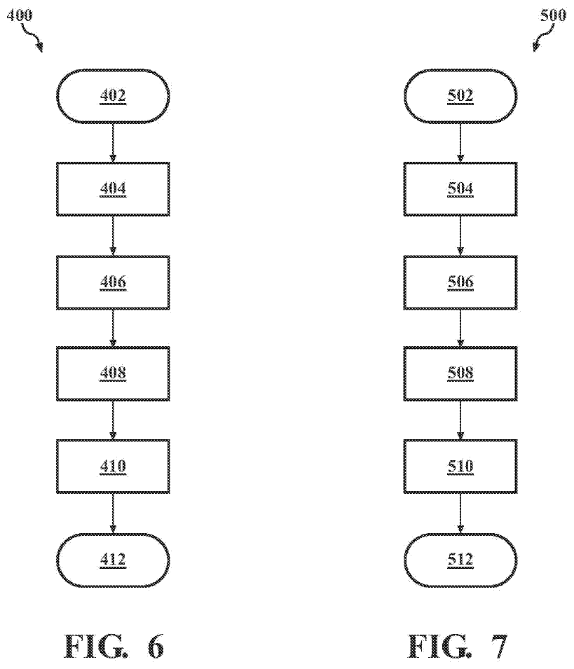

FIG. 6 is a flowchart illustrating a first method 400 for a localized thermal barrier at a positive battery terminal and can interface of a battery. The method 400 is described in relation to the battery cell 10 of FIG. 1, although the method 400 may be applied to other embodiments of battery cells. The method 400 starts at step 402. At step 404, various components of the battery cell 10 in a disassembled state are prepared for assembly together to form the battery cell 10, and the battery cell 10 is partially assembled to a point where the positive battery terminal 40 of FIG. 1 is attached and protruding through the can 20, and the insulator 60 is in place around the positive battery terminal 40. At step 406, the thermal barrier 70 of FIG. 1 is created around the positive battery terminal 40, creating a redundant seal around the positive battery terminal 40 and preventing gases from flowing through a gap between the can 20 and the positive battery terminal 40. At step 408, assembly of the battery cell 10 is completed. At step 410, the battery cell 10 is utilized in a useful application, with gases existing within the battery cell 10 being prevented from escaping through a gap between the positive battery terminal 40 and the can 20. The method 400 ends at step 412. The method 400 is exemplary, a number of alternative and/or additional steps are envisioned, and the disclosure is not intended to be limited to the examples provided herein.

FIG. 7 is a flowchart illustrating a second method 500 for a localized thermal barrier at a positive battery terminal and can interface of a battery. The method 500 is described in relation to the battery cell 10 of FIG. 1, although the method 500 may be applied to other embodiments of battery cells. The method 500 starts at step 502. At step 504, various components of the battery cell 10 in a disassembled state are prepared for assembly together to form the battery cell 10. At step 506, the battery cell 10 is assembled with an exception that the thermal barrier 70 is not yet created. At step 508, the thermal barrier 70 of FIG. 1 is created around the positive battery terminal 40, creating a redundant seal around the positive battery terminal 40 and preventing gases from flowing through a gap between the can 20 and the positive battery terminal 40. At step 510, the battery cell 10 is utilized in a useful application, with gases existing within the battery cell 10 being prevented from escaping through a gap between the positive battery terminal 40 and the can 20. The method 500 ends at step 512. The method 500 is exemplary, a number of alternative and/or additional steps are envisioned, and the disclosure is not intended to be limited to the examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. An apparatus for a battery cell, comprising:
the battery cell, including:
an electrode stack including at least one pair of an anode electrode and a cathode electrode;
a can including a wall encapsulating the electrode stack;
a positive battery terminal connected to the electrode stack and projecting outside of the can;
a negative battery terminal connected to the electrode stack, wherein the positive battery terminal and the negative battery terminal are configured for providing electrical energy; and
a thermal barrier adjoining the can and the positive battery terminal, wherein the thermal barrier seals gases within the battery cell from exiting the battery cell between the can and the positive battery terminal at an ambient temperature of at least 600° C.

2. The apparatus of claim 1, wherein the thermal barrier is constructed with an epoxy, a room-temperature vulcanizing silicone, or polyurethane.

3. The apparatus of claim 1, wherein the battery cell further includes an insulator disposed between the can and the positive battery terminal; and
wherein the thermal barrier is disposed to cover an outside surface of the insulator.

4. The apparatus of claim 1, wherein the electrode stack is a jellyroll electrode stack; and
wherein the can is cylindrically shaped.

5. The apparatus of claim 1, wherein the can is a rectangularly-shaped prismatic can.

6. The apparatus of claim 1, wherein the battery cell further includes a vent configured for permitting the gases to escape from the battery cell through the vent.

7. The apparatus of claim 6, wherein the battery cell includes a first end portion and a second end portion distal from the first end portion;
wherein the thermal barrier is disposed upon the first end portion; and
wherein the vent is disposed upon the second end portion.

8. The apparatus of claim 1, wherein the thermal barrier includes a first thermal barrier; and
wherein the battery cell further includes a second thermal barrier surrounding the negative battery terminal.

9. A device including a battery cell, comprising:
the device, including:
the battery cell, including:
an electrode stack including at least one pair of an anode electrode and a cathode electrode;
a can including a wall encapsulating the electrode stack;
a positive battery terminal connected to the electrode stack and projecting outside of the can;
a negative battery terminal connected to the electrode stack, wherein the positive battery terminal and the negative battery terminal are configured for providing electrical energy; and
a thermal barrier adjoining the can and the positive battery terminal, wherein the thermal barrier seals gases within the battery cell from exiting the battery cell between the can and the positive battery terminal at an ambient temperature of at least 600° C.

10. The device of claim 9, wherein the device includes a vehicle.

11. The device of claim 9, wherein the thermal barrier is constructed with an epoxy, a room-temperature vulcanizing silicone, or polyurethane.

12. The device of claim 9, wherein the battery cell further includes an insulator disposed between the can and the positive battery terminal; and
wherein the thermal barrier is disposed to cover an outside surface of the insulator.

13. The device of claim 9, wherein the electrode stack is a jellyroll electrode stack; and
wherein the can is cylindrically shaped.

14. The device of claim 9, wherein the can is a rectangularly-shaped prismatic can.

15. The device of claim 9, wherein the battery cell further includes a vent configured for permitting the gases to escape from the battery cell through the vent.

16. The device of claim 15, wherein the battery cell includes a first end portion and a second end portion distal from the first end portion;
wherein the thermal barrier is disposed upon the first end portion; and
wherein the vent is disposed upon the second end portion.

17. The device of claim 9, wherein the thermal barrier includes a first thermal barrier; and
wherein the battery cell further includes a second thermal barrier surrounding the negative battery terminal.

18. A method for a battery cell including a thermal barrier at a positive battery terminal and can interface, the method comprising:
creating the thermal barrier including a coating of thermal barrier material around a perimeter of the positive battery terminal of the battery cell configured for adjoining the positive battery terminal and a can of the battery cell and for sealing gases within the battery cell from exiting the battery cell between the positive battery terminal and the can; and
wherein the thermal barrier material is configured to continue sealing the gases within the battery cell at an ambient temperature of at least 600° C.

19. The method of claim 18, wherein creating the thermal barrier is performed prior to the battery cell is fully assembled.

20. The method of claim 18, wherein creating the thermal barrier is performed after a remainder of the battery cell is fully assembled.
